(19) United States
(12) Patent Application Publication
(10) Pub. No.: US 2016/0366888 A1
(43) Pub. Date: Dec. 22, 2016

(54) ENVIRONMENTALLY FRIENDLY FORMULATIONS FOR BI-COMPONENT HETEROCYCLIC SCHIFF BASE TEXTILE FINISHES

(71) Applicant: Government of the United States as Represented by the Secretary of the Air Force, Wright-Patterson AFB, OH (US)

(72) Inventors: Jeffery R. Owens, Panama City, FL (US); Guinevere Strack, Port Saint Joe, FL (US); Katherine Simpson, Panama City, FL (US)

(73) Assignee: Government of the United States as Represented by the Secretary of the Air Force, Wright-Patterson AFB, OH (US)

(21) Appl. No.: 15/152,641

(22) Filed: May 12, 2016

Related U.S. Application Data
(63) Continuation-in-part of application No. 14/029,952, filed on Sep. 18, 2013.
(60) Provisional application No. 62/160,874, filed on May 13, 2015.

(51) Int. Cl. A01N 43/80; D06M 13/352; D06M 13/355; A01N 43/40; A01N 43/42

(52) U.S. Cl. CPC A01N 43/80; A01N 43/40; A01N 43/42; D06M 13/355; D06M 13/352

(57) ABSTRACT

An environmentally friendly, antimicrobial solution. The antimicrobial solution includes a first biocide comprising a compound having at least one Schiff base, an organic acid, a second biocide, and water.

Pursuant to 37 C.F.R. §1.78(a)(4), this application claims the benefit of and priority to prior filed co-pending Provisional Application Ser. No. 62/160,874, filed May 13, 2015. This application is also a continuation-in-part application of co-pending Non-Provisional application Ser. No. 14/029,952, filed Sep. 18, 2013, which is related to International Application Serial No. PCT/GB14/052828, filed Sep. 17, 2014. The disclosure of each of these prior filed Applications is expressly incorporated herein by reference, in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to treatments for substrates and, more particularly, to treatments of fabrics and textiles.

### BACKGROUND OF THE INVENTION

Some materials, including, for example, garments, worn by first responders and soldiers are conventionally pretreated to protect the wearer from exposure to poisonous chemicals. The pretreatments can be applied to a wide variety of surfaces and substrates including, for example, coatings, textiles, plastics, metals, ceramics, and polymers. In operation, the treatments usually detoxify poisonous chemicals by oxidation or by preventing skin contact through repellant coatings and absorbents.

However, these conventional treatments often damage or degrade the surface or substrate on which it is applied. Alternatively, or additionally, the conventional treatments cause respiratory irritation and/or contact dermatitis in the wearer. Moreover, the conventional treatments are stoichiometric in nature—that is, each molecule of the conventional treatments neutralizes, decontaminates, or otherwise reacts with a particular number of molecules of the poisonous chemical. In some instances, the stoichiometry is one-to-one. Therefore, and over time, the treatment becomes less effective and may, in other words, wear out or be rendered completely ineffective.

U.S. application Ser. No. 14/029,952, filed Sep. 18, 2013, and entitled SELECT SCHIFF BASE COMPOUNDS FOR CHEMICAL AGENT DETOXIFICATION, provides the application of Schiff base compounds to substrates. However, these applications require a non-aqueous formula (such as acetone). During scaled-up processes, such applications would require large quantities of a flammable solvent, which presents both a health and safety concern. Moreover, there is a desire to make use of such applications in a cost-effective manner.

Accordingly, there remains a need for substrate treatment chemicals by which a wide range of poisonous chemical agents can be neutralized so as to protect the wearer, while limiting damaging effects on the substrate or surface on which it is applied, and while limited health and safety concerns.

### SUMMARY OF THE INVENTION

The present invention overcomes the foregoing problems and other shortcomings, drawbacks, and challenges of the conventional substrate treatment chemicals. While the invention will be described in connection with certain embodiments, it will be understood that the invention is not limited to these embodiments. To the contrary, this invention includes all alternatives, modifications, and equivalents as may be included within the spirit and scope of the present invention.

According to an embodiment of the present invention, an environmentally friendly, antimicrobial solution includes a first biocide comprising a compound having at least one Schiff base, an organic acid, a second biocide, and water.

Other embodiments of the present invention are directed to an antimicrobial mix comprising a first biocide salt comprising a compound having at least one Schiff base treated with a mineral acid, an organic acid, and a second biocide.

According to yet other embodiments of the present invention, an antimicrobial substrate includes a surface with a first biocide and a second biocide chemical bound to the surface by a cross-linking agent. The first biocide comprises a compound having at least one Schiff base.

Additional objects, advantages, and novel features of the invention will be set forth in part in the description which follows, and in part will become apparent to those skilled in the art upon examination of the following or may be leaned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIGS. 1A and 1B are representations of pretreatment chemicals according to embodiments of the present invention.

FIG. 2 is a representation of a chemical mechanism by which pretreatment chemicals according to embodiments of the present invention may neutralize sarin, a neurotoxic agent.

FIGS. 3A and 4A are representations of pretreatment chemicals according to other embodiments of the present invention.

FIGS. 3B and 4B are representations of resonance tautomers of the pretreatment chemicals of FIGS. 3A and 4A, respectively.

FIG. 5 is a flowchart illustrating a method of treating a substrate with a pretreatment solution according to one embodiment of the present invention.

FIGS. 6A and 6B are schematic illustrations of exemplary agar samples prepared without and with pretreatment, respectively, according to an embodiment of the present invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The present invention relates to compounds for chemical agent detoxification and methods of applying the compounds to substrates for detoxification thereof or treatment prior to exposure to the chemical agent.

As used herein, “alkyl” means a branched or unbranched, alkane or alkene substituent consisting of carbon and hydrogen, for example, methyl, ethyl, propyl, isopropyl, 1-butyl, 2-butyl, isobutyl, tert-butyl, pentyl, 2-methylbutyl, 1,1-dimethylpropyl, hexyl, heptyl, octyl, nonyl, and decyl.

As used herein, “aryl” means a cyclic, aromatic substituent consisting of hydrogen and carbon, for example, phenyl, naphthyl, and biphenylyl.

As used herein, “carboxylic acid” is a class of compounds having a formula —C(═O)OH.

As used herein, “carboxylate” means any salt of carboxylic acid.

As use herein, “organic acid” means any organic compound having acidic properties. For example, the activity may be associated with a carboxylic moiety attached to an alkyl or aryl substituent.

As used herein, “Schiff base nitrogen” is defined as the nitrogen atom of a carbon-nitrogen double bond, wherein the nitrogen atom is chemically bonded to the alkyl or aryl and not to a hydrogen atom.

As used herein, “substituted” is defined by the substitution of a hydrogen on a carbon by a univalent group including, but not limited to, halogen, hydroxy, thiol, amino, nitro, cyano, C1-C4 alkyl, alkylamino, carboxy, amido, vinyl, and C1-C5 alkoxy.

As use herein, “amine” is a basic nitrogen atom with a lone pair of electrons. Amines can be primary, secondary, or tertiary with alky substituents.

As used herein, “sulfonic acid” is a class of compounds having a formula S(═O)2—OH.

As used herein, “sulfonate” means any salt or ester of sulfonic acid.

“Lewis acid,” as used herein, is defined as a chemical substance that can employ an electron lone pair from another molecule.

“Lewis base,” as used herein, is defined as any chemical substance that donates a pair of electrons to a Lewis acid.

“Tautomers,” as used herein, are structural isomers of organic compounds that are in dynamic equilibrium due to the migration of a proton.

“Biocide” or “antimicrobial,” as used herein, include germicides, bactericides, fungicides, and algicides, which are useful in inhibiting growth of and/or destroy a biological threat.

“Biological threat,” as used herein, is any of a range of microbial or viral threat agents, including, for example, Gram-positive bacteria, Gram-negative bacterial, bacterial spores, fungal spores, and viruses. Exemplary biological threats include, but are not limited to: Staphylococcus aureus, Escherichia coli, Pseudomonus fluorescens, Bacillus atrophaeus, Bacillus anthracis spores (Sterne strain), Aspergillus niger, MS2 coliphage, Pseudomonus aeruginosa, Bacillus anthracis, Bacillus azotoformans, Bacillus cereus, Bacillus coagulans, Bacillus israelensis, Bacillus larvae, Bacillus mycoides, Bacillus polymyxa, Bacillus pumilis, Bacillus stearothormophillus, Bacillus subtilis, Bacillus thuringiensis, Aspergillus flavus, Penicillium islandicum, Penicillium citrinum, Penicillium chrysogenum, Fusarium oxysporum, Fusarium graminearum, Fusarium solani, Alternaria alternata, and Mucor racemosus.

“Substrate,” as used herein, is any surface or material that may be, or has been, treated with a Schiff base. Substrates may include, for example, textiles, polymers, coatings, conductive materials, plastics, metals, and ceramics.

“Mineral acid,” as used herein, is any acid derived from an inorganic compound. Mineral acids may include, for example, sulfuric acid, hydrochloric acid, and nitric acid.

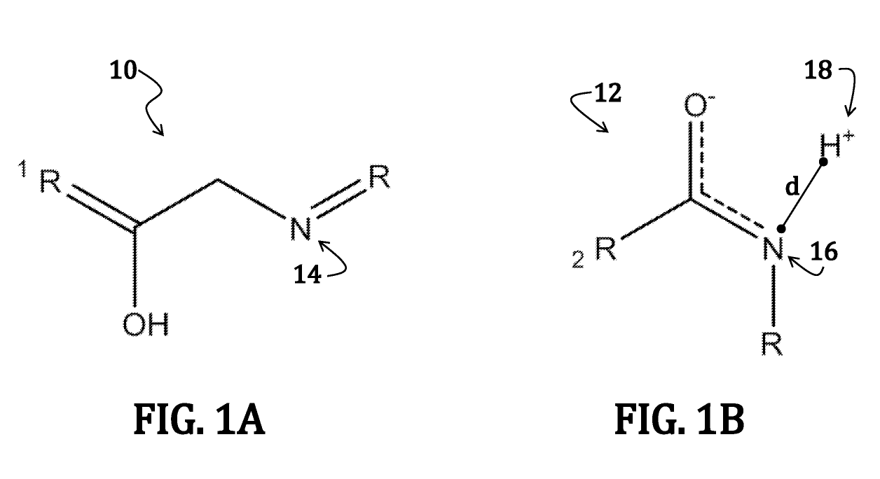

Referring now to the figures, and in particular to FIGS. 1A and 1B, pretreatment chemicals 10, 12 according to embodiments of the present invention are shown, wherein each of R, ¹R, and ₂R is an alkyl substituent or an aryl substituent. Generally, the pretreatment chemicals 10, 12 comprise an imine (e.g., a Lewis base) and an alkyl substituent or an aryl substituent and are configured to detoxify a chemical agent having at least one leaving group. A Schiff base nitrogen 14, 16 of the imine is separated from an electron acceptor (for example, acidic proton 18) by a distance, d, that ranges from about 2 bond length radii to about 10 bond length radii (that is, from about 200 pm to about 1000 pm) as determined, for example, by molecular mechanics (MM+) geometry optimization (conjugate gradient; RMS gradient 0.0001 kcal/Å·mol).

If desired, the pretreatment chemical may further comprise a cross-linking agent that is configured to form a cross-linkage chemical bond between the pretreatment chemical and a substrate.

It will be readily appreciated by the skilled artisan that the pretreatment chemical 12 illustrated in FIG. 1B is shown as a thermodynamic minimum representation, that is, as a canonical resonance form.

According to another embodiment of the present invention, a pretreatment chemical comprises a catalyst configured to react with Lewis acids, the catalyst having an electron acceptor (for example, an acidic proton) spaced away from a Schiff base nitrogen by a distance that ranges from about 200 pm to about 1000 pm (or from about 2 bond length radii to about 10 bond length radii). More specifically the catalysts are configured to react with and detoxify toxic pesticides and potent nerve agents, including, for example, phosphoric acid esters (sarin, soman, VX, diisopropyl fluorophosphates, etc.), and blister agents, (such as bis(2-chloroethyl) sulfide) having at least one leaving group. Examples of leaving groups may include, but are not limited to, one or more halide ions, thiolates, amines, alcohols, perfluoroalkylsulfonates, tosylates, and cyanide. The remaining electrophile may contain phosphorus, sulfur, arsenic, or nitrogen.

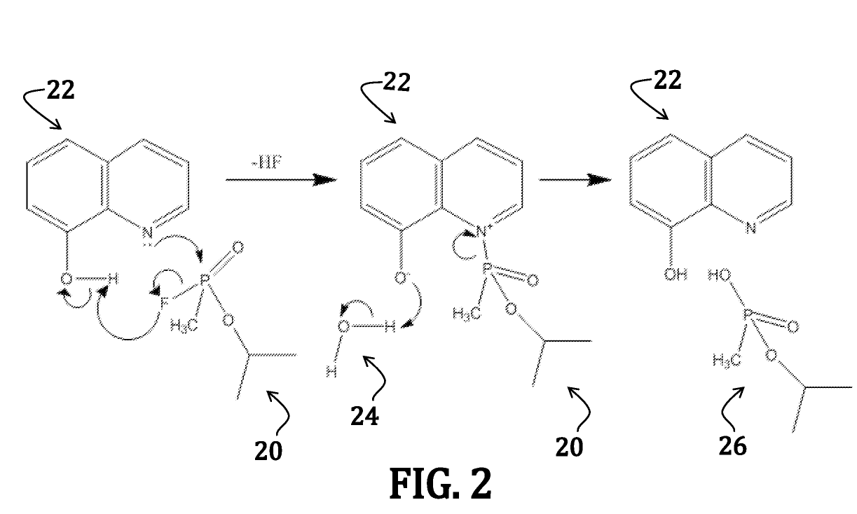

While not wishing to be bound by theory, it is believed that, for example, phosphoric acid esters may be decontaminated with the pretreatment chemicals of the present invention in accordance with the mechanism illustrated in FIG. 2. More particularly, FIG. 2 illustrates a reaction between sarin 20 ([(CH₃)₂CHO]CH₃P(O)F), an organophosophorus compound used in chemical warfare as an extremely potent nerve agent, and 8-hydroxyquinoline 22 (hereafter, “8-HQ”), a pretreatment chemical according to one embodiment of the present invention. 8-HQ 22 is a known antiseptic approved for multiple uses by the USDA. As shown, the imine group of 8-HQ 22 serves as a Lewis base that “attacks” the phosphorous center of the sarin 20 (i.e., a Lewis acid). The attack leads to a subsequent loss of HF from the system. The 8-HQ 22 activity may be regenerated by reacting with a water molecule 24, which donates a proton to the phenolate ion. 8-HQ 22 is regenerated in the presence of water by hydrolytic attack of the phosphorus atom of the 8-HQ-agent adduct, followed by release of a neutralized phosphonic acid product 26.

A similar mechanism, although not shown, is expected for an opthamolic drug, diisopropyl fluorophosphates (a cholinergic molecule), and the nerve agent, soman (O-pinacolyl methylphosphonofluoridate).

Mustard compounds, such as 2-chloroethyl ethyl sulfide and bis(2-chlorethyl)sulfide, are also expected to follow a similar mechanism. That is, a lone pair of electrons from the Schiff base nitrogen serves as the Lewis base and attacks the #2 carbon bonded to the chlorine or the a carbon bonded to sulfur in the episulfonium configuration. In concerted fashion, the chlorine picks up the local acidic hydrogen. In the presence of water, the phenolate ion from 8-HQ regains a proton from a local water molecule, and the remaining hydroxide allows regeneration of the catalyst to form from the water. Such a mechanism results in either elimination to form a vinyl product (anhydrous), or, in the presence of water, substitution to form thiodiglycol or 1,4-oxathiane, all of which are acceptably nontoxic decontamination products.

A similar mechanism is also expected for treatments against toxic industrial chemicals, such as acrolein (CH₂CHCHO), that is, through a catalytic reduction to 2-propen-1-ol in the presence of atmospheric water vapor.

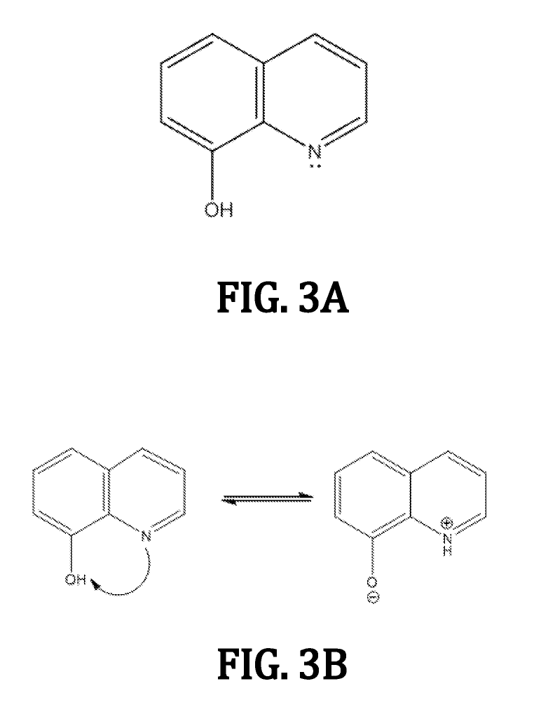

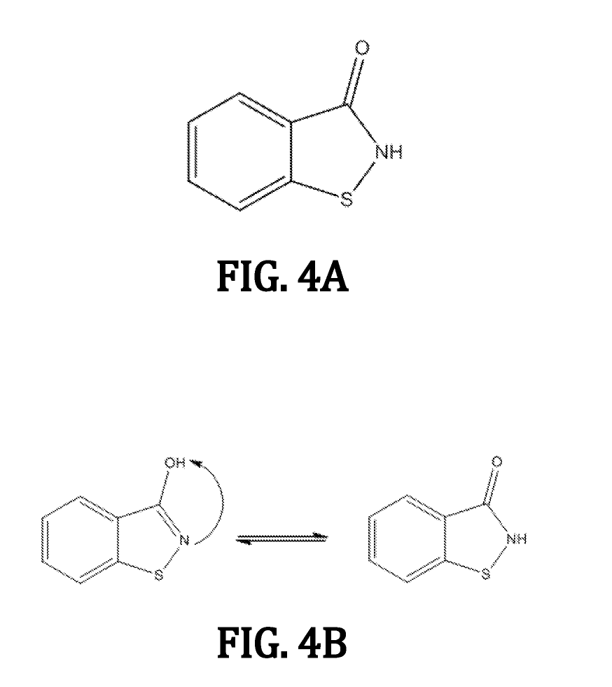

FIGS. 3A and 4A are representations of pretreatment chemicals according to still other embodiments of the present invention. Particularly, FIG. 3A is 8-HQ and FIG. 4A is 1,2-benzisothiazol-3(2H)-one (hereafter, “BIT”), which is commercially-available under the tradename BIOBAN from Dow Corning and is described in detail in U.S. Application Publication No. 2010/0125095, entitled BIOCIDAL COMPOSITION OF 2,6-DIMETHYL-M-DIOXANE-4-OL ACETATE AND METHODS OF USE, as an anti-fouling additive for coatings. BIT is approved for use in Asia and is expected to be approved for use in the US in the near future.

Resonance tautomers of 8-HQ and BIT are shown in FIGS. 3B and 4B, respectively.

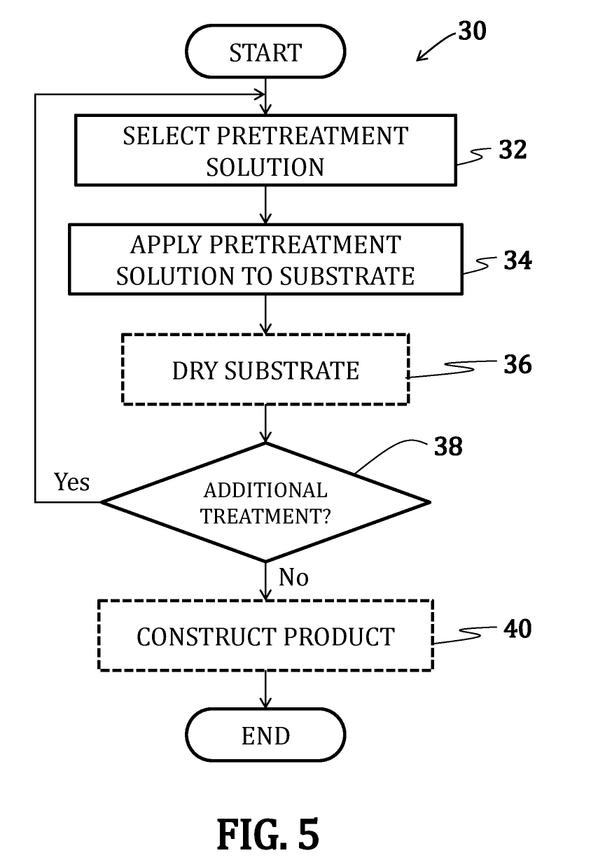

With reference now to FIG. 5, a flowchart 30 illustrating a method of using an antimicrobial solution according to one embodiment of the present invention is shown. In Block 32, a pretreatment solution according to one embodiment of the present invention is selected, wherein the selection is based, at least in part, on an anticipated agent exposure.

The pretreatment solution comprises, generally, of a first biocide, an organic acid, water, and a second biocide. Selection of the first and second biocides may depend, at least in part, on the anticipated agent, which may include any environmental toxin, chemical warfare agent, pesticide, industrial chemical, and so forth. Section of the pretreatment chemical may also be based on the known chemical structure of the anticipated agent such that the pretreatment chemical may under an appropriate detoxification mechanism, similar to those described above.

The first biocide may be any Schiff base, as described herein as being a pretreatment chemical, and having a concentration of such first biocide may range from about 0.1% to about 40.0%. In particular, the first biocide may include BIT, any derivatives of BIT, or combinations thereof. Derivatives of BIT include but not limited to N-methyl-1,2-benzisothiazol-3(2H)-one (MBIT), 2-Methyl-4-Isothiazole-3-One MIT, 2-methyl-3(2H)-isothiazolone (“CMIT”), 4,5-dichloro-2-n-octyl-4-isothiazolin-3-one (“DCOIT”), 2-Methyl-4-Isothiazolin-3-one (“OIT”). According to other embodiments of the present invention, the first biocide may be 8-HQ, any derivative of 8-HQ, or combinations thereof. Derivatives of 8-HQ include but not limited to 8-HQ hemisulfate, 8-hydroxy-2-quinolinecarbaldehyde, 5,7-dibromo-8-hydroxyquinoline, 5,7-dichloro-8-hydroxyquinoline, 7-iodo-8-hydroxyquinoline, 5-chloro-7-iodo-8-hydroxyquinoline, xanthurenic acid, 3-(quinolin-8-yloxy)propane-1,2-diol, 8-hydroxy-5-quinolinesulfonic acid, 5-Amino-8-hydroxyquinoline, 8-quinolinethiol hydrochloride, 5,7-diiodo-8-hydroxyquinoline, 2-carboxyquinoline.

The organic acid for use with the pretreatment solution may include any organic compound having at least one carboxyl group or phenolic group and a concentration of such organic acid may range from about 1.0% to about 90.0%. Suitable organic acids may include, but are not limited to, acetic acid, formic acid, propanoic acid butyric acid, lactic acid, acrylic acid, methylacrylic acid, pyruvic acid, citric acid, formic acid, malic acid, fumaric acid, glutamic acid, oxalic acid, succinic acid, levulinic acid, benzioc acid, phthalic acid, phenol, and any derivative, co-polymer, or homo-polymer of the foregoing.

The second biocide may, according to some embodiments of the present invention, include be any Schiff base, as described herein and having a concentration of such first biocide may range from about 0.1% to about 60.0% Suitable Schiff bases may include BIT, 8-HQ, derivatives of BIT, derivatives of 8-HQ, or combinations thereof, as provided in greater detail above. According to still other embodiments of the present invention, the second biocide may include pyridine, a pyridine derivative, a co-polymer of pyridine, or a homo-polymer of pyridine. Suitable derivatives may include, but are not limited to, pyridine, pyridinium salts, 2-cyanomethylthiopyridine-4-carbonitrile, 1-adamantylthiopyridines, poly(vinylpyridine), and poly(vinylamine-co-4-aminopyridine).

Water comprising the remainder of the pretreatment solution may range from 1.0% to 95.0% of the total volume.

Generally, a pH of the pretreatment solution may range from 0 to 5.5.

According to some embodiments of the present invention, although not specifically illustrated in FIG. 5, the first biocide may be treated with a mineral acid to form a salt before the solution is prepared and mixed. In this way, the first biocide may be stable for long term storage and readily dissolvable in aqueous solution when the pretreatment solution is needed.

With the first biocide, the organic acid, the second biocide, water, and the desired concentrations thereof determined, the pretreatment solution may be prepared by mixing the elements (that is, the first biocide, the organic acid, the second biocide, and the water) and either shear mixing or vortexing the solution.

With the pretreatment solution selected, a quantity of the selected pretreatment solution is applied to a substrate (Block 34). The substrate, while referenced here as being a fabric or textile, may include any suitable coating, textile (woven and nonwovens), plastic, metal, ceramic, polymer, and so forth. Application of the pretreatment solution may be direct, that is, without dilution, or by dissolving or suspending a quantity of the pretreatment solution in an organic or aqueous solvent (for example, a 0.1%-30% solution) that is then applied to the substrate. In any event, the pretreatment solution may bind to (for example, via cross-linking) or otherwise be retained by (for example, via intercalation) a material comprising the substrate. With respect to cross-linking, the pretreatment solution may include conventional cross-linking chemistries including, for example, siloxanes, acrylates, radical polymerization, epoxides, and so forth. Generally, application of the pretreatment chemical may range from about 0.1 wt. % to about 5.0 wt. %.

If desired or necessary, the substrate may optionally be dried (Block 36). Drying may additionally or alternatively include heating, for example, in an oven (such as with exemplary temperatures ranging from about 75° C. to about 200° C.) or microwave. However, drying at temperatures above about 200° C. may damage textile fibers, melt polyolefins, or both. Cross-linking by drying may include an initiator, which may be a chemical initiator, light, or other forms of electromagnetic radiation. According to some embodiments including siloxanes, cross-linking may also occur with changes in pH.

It will be readily appreciated by those of ordinary skill in the art having the benefit of the disclosure provided herein that a plurality of pretreatment solution according to various embodiments of the present invention may be applied to the same substrate. In that regard, applications of pretreatment solutions may be simultaneous or sequential. As shown in FIG. 5, and when an additional treatment is desired (“Yes” branch of Decision Block 38), then the process returns and a pretreatment solution according to another embodiment of the present invention is selected (Block 32). Otherwise, (“No”, branch of Decision Block 38), the process continues. Accordingly, resultant coatings may comprise a combination of pretreatment solution, such as 2.5% BIT and 2.5% 8-HQ; however, other combinations are also envisioned within the scope of this disclosure.

It would also be appreciated that the pretreatment solution may be applied to substrate prior to or after manipulation of the substrate. For example, fabric comprising a garment may be treated prior to or after garment construction. Therefore, the treated substrate may optionally be used to construct a product, for example, a garment or headgear, or activated carbon, carbon beads, or carbon cloth (Block 40). Otherwise, although not specifically shown in FIG. 5, the substrate may be manipulated prior selection of the pretreatment solution.

According to still other embodiments of the present invention, the substrate may be treated after exposure to an agent. In that regard, the treatment may be for purposes of remediation, demilitarization, or detoxification rather than protection or prevention.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### EXAMPLE 1

Aqueous solutions of 1,2-benzisothiazolin-3-one (BIT) comprising were prepared by mixing 1% to 40% by wt. of BIT; 1% to 90% by wt. of acetic acid; 1% to 95% by wt. of water; and 0.1% to 60% by wt. of 8-hydroxyquinoline (8-HQ) via shear mixing or vortexing. Each aqueous solution prepared and applied to cotton fabric and tested for antimicrobial activity. Results are shown in Table 1, below.

In Table 2, below, “5+” represents a zone of inhibition ranging 41 mm to 50 mm; “4+” represents a zone of 31 mm to 40 mm; “3+” represents a zone of 21 mm to 30 mm; “2+” represents a zone of 11 mm to 20 mm; “1+” represents a zone of 1 mm to 10 mm; and “−” represents no antimicrobial activity noted.

TABLE 1

| | S. aureus | B. subtilis | P. fluorescens | E. coli |
|---|---|---|---|---|
| 1% 8HQ + 0.5% BIT | Cleared all but | Cleared all of | 15, 14 mm zone | 16, 12 mm zone |
| | a few edge | the plates | of inhibition | of inhibition |
| | colonies on all | | 15, 14 mm zone | 14, 14 mm zone |
| | plates | | of inhibition | of inhibition |
| | | | 15, 14 mm zone | 18, 14 mm zone |
| | | | of inhibition | of inhibition |
| 8HQ hemisulfate + | Cleared all but | Cleared all but | 10, 20 mm zone | 11, 7 mm zone |
| BIT salt | a few edge | a few edge | of inhibition | of inhibition |
| | colonies on all | colonies on all | 10, 12 mm zone | 11, — mm zone |
| | plates | plates | of inhibition | of inhibition |
| | | | 15, 14 mm zone | 18, 14 mm zone |
| | | | of inhibition | of inhibition |
| BIT | Cleared all but | 24, 27 mm zone | 9, 10 mm zone | 9, 10 mm zone |
| | a few edge | of inhibition | of inhibition | of inhibition |
| | colonies on all | 22, 24 mm zone | 11, 9 mm zone | 12, 7 mm zone |
| | plates; slightly | of inhibition | of inhibition | of inhibition |
| | more growth | 23, 25 mm zone | 7, 12 mm zone | 8, 12 mm zone |
| | than A&B | of inhibition | of inhibition | of inhibition |
| | plates | | | |
| BIT salt | 6, 10 mm zone | 18, 18 mm zone | 7, 7 mm zone | 13, 8 mm zone |
| | of inhibition | of inhibition | of inhibition | of inhibition |
| | 7, 11 mm zone | 15, 15 mm zone | 7, 9 mm zone | 12, 9 mm zone |
| | of inhibition | of inhibition | of inhibition | of inhibition |
| | 5, 10 mm zone | 16, 16 mm zone | 6, 7 mm zone | 6, 6 mm zone |
| | of inhibition | of inhibition | of inhibition | of inhibition |
| 8HQ | Cleared all but | 25, 25 mm zone | 8, 12 mm zone | 16, 12 mm zone |
| | a few edge | of inhibition; | of inhibition | of inhibition |
| | colonies on all | cleared plates 2 | 9, 7 mm zone | 14, 14 mm zone |
| | plates | and 3 | of inhibition | of inhibition |
| | | | 15, 12 mm zone | 18, 14 mm zone |
| | | | of inhibition | of inhibition |
| Quinolinol salt | Cleared all of | Cleared all but | 15, 20 mm zone | 11, 9 mm zone |
| hemisulfate | the plates | a few edge | of inhibition | of inhibition |
| | | colonies on all | 15, 15 mm zone | 14, 11 mm zone |
| | | plates | of inhibition | of inhibition |
| | | | 12, 20 mm zone | 16, 16 mm zone |
| | | | of inhibition | of inhibition |
| Quinolinol salt | Cleared all of | Cleared all but | 7, 11 mm zone | 9, 11 mm zone |
| hemisulfate (1 g) + BIT | the plates | a few edge | of inhibition | of inhibition |
| (0.750 g) | | colonies on all | 9, 10 mm zone | 14, 17 mm zone |
| | | plates | of inhibition | of inhibition |
| | | | 11, 9 mm zone | 10, 8 mm zone |
| | | | of inhibition | of inhibition |
| No antimicrobial- | Growth up to | Growth up to | Growth up to | Growth up to |
| scoured SBC | and under | and under | and under | and under |
| | samples | samples | samples | samples |

TABLE 2

| | S. aureus | B. subtilis | P. fluorescens | E. coli |
|---|---|---|---|---|
| 1% 8HQ + | ++++ | +++++ | ++ | ++ |
| 0.5% BIT | ++++ | +++++ | ++ | ++ |
| | ++++ | +++++ | ++ | ++ |
| 8HQ hemisulfate + | ++++ | ++++ | ++ | + |
| BIT salt | ++++ | ++++ | ++ | + |
| | ++++ | ++++ | ++ | ++ |
| BIT | ++++ | ++ | + | + |
| | ++++ | ++ | + | + |
| | ++++ | ++ | + | + |
| BIT salt | + | ++ | + | ++ |
| | + | ++ | + | ++ |
| | + | ++ | + | + |
| 8HQ | ++++ | +++ | ++ | ++ |
| | ++++ | +++++ | + | ++ |
| | ++++ | +++++ | ++ | ++ |
| Quinolinol salt | +++++ | ++++ | ++ | ++ |
| hemisulfate | +++++ | ++++ | ++ | ++ |
| | +++++ | ++++ | ++ | ++ |
| Quinolinol salt | +++++ | ++++ | + | ++ |
| hemisulfate (1 g) + | +++++ | ++++ | + | ++ |
| BIT (0.750 g) | +++++ | ++++ | + | + |
| No antimicrobial- | − | − | − | − |
| scoured SBC | − | − | − | − |
| | − | − | − | − |

### EXAMPLE 2

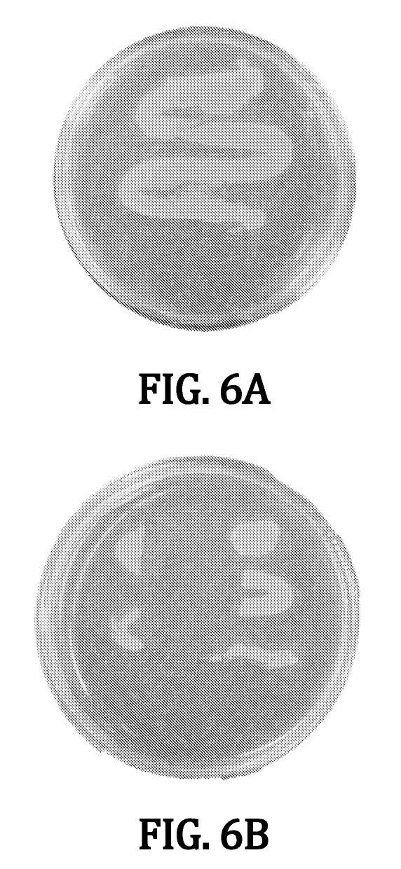

The American Association of Textile Chemists and Colorists (AATCC) test method 147, Antibacterial Assessment of Textile Materials was used to qualitatively test the biocidal efficacy of pretreatment solutions according to an embodiment of the present invention. Test material was aseptically transferred directly onto the surface of an inoculated nutrient agar slurry. After a specified incubation contact time, the test material was removed and any growth, or lack thereof, beneath the test material surface is recorded. FIG. 6A illustrates a negative control sample; FIG. 6B illustrates a positive sample.

ASTM method E2180-1, Standard Test for Determining the Activity of Incorporated Antimicrobial Agent(s) in Polymeric or Hydrophobic Materials was used to determine the biocidal efficacy of hydrophobic surfaces and substrates. In that regard, test material was aseptically transferred directly onto the surface of an inoculated nutrient agar slurry. After a specified incubation contact time series, the test material is removed and any growth, or lack thereof, beneath the test material surface is recorded. The test material was then washed to re-suspend nutrient agar plates. The plates were incubated for a specified period of time and the resulting colonies counted. Contact efficacy times as well as growth trends associated with the test material were determined as uninhibited growth, bacteriostasis, and inhibited growth.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. An antimicrobial solution comprising:
a first biocide comprising a compound having at least one Schiff base;
an organic acid;
a second biocide; and
water.

2. The antimicrobial solution of claim 1, wherein the first biocide comprises 1,2-benzisothiazolin-3-one, a derivative thereof, or combinations thereof.

3. The antimicrobial solution of claim 1, wherein the first biocide comprises 0.1% to 40.0% of a total volume of the antimicrobial solution.

4. The antimicrobial solution of claim 1, wherein the second biocide comprises a compound having at least one Schiff base.

5. The antimicrobial solution of claim 4, wherein the second biocide comprises 8-hydroxyquinoline, a derivative thereof, or combinations thereof.

6. The antimicrobial solution of claim 1, wherein the second biocide comprises pyridine, a derivative thereof, a co-polymer thereof, a homo-polymer thereof, or combinations thereof.

7. The antimicrobial solution of claim 1, wherein the second biocide comprises 0.1% to 40% of a total volume of the antimicrobial solution.

8. The antimicrobial solution of claim 1, wherein the organic acid comprises any compound having one or more carboxyl moieties or one or more phenolic moieties.

9. The antimicrobial solution of claim 8, wherein the organic acid is selected from the group consisting of: acetic acid, formic acid, propanoic acid butyric acid, lactic acid, acrylic acid, lactic acid, methylacrylic acid, pyruvic acid, citric acid, formic acid, malic acid, fumaric acid, glutamic acid, oxalic acid, succinic acid, levulinic acid, and benzioc acid, phthalic acid, and phenol.

10. The antimicrobial solution of claim 1, wherein the organic acid comprises 1.0% to 90% of a total volume of the antimicrobial solution.

11. The antimicrobial solution of claim 1, wherein the first biocide comprises 1,2-benzisothiazolin-3-one, a derivative thereof, or combinations thereof and the second biocide comprises 8-hydroxyquinoline, a derivative thereof, or combinations thereof or pyridine, a derivative thereof, a co-polymer thereof, a homo-polymer thereof, or combinations thereof.

12. The antimicrobial solution of claim 1, further comprising:
a cross-linking agent configured to chemically bind the first and second biocides to a substrate.

13. The antimicrobial solution of claim 12, wherein the cross-linking agent is a siloxane, an acrylate, an epoxide, or combinations thereof.

14. The antimicrobial solution of claim 12, wherein the first biocide comprises 1,2-benzisothiazolin-3-one, a derivative thereof, or combinations thereof and the second biocide comprises 8-hydroxyquinoline, a derivative thereof, or combinations thereof or pyridine, a derivative thereof, a co-polymer thereof, a homo-polymer thereof, or combinations thereof.

15. An antimicrobial mix comprising:
a first biocide salt comprising a compound having at least one Schiff base treated with a mineral acid;
an organic acid; and
a second biocide.

16. The antimicrobial mix of claim 15, wherein the first biocide salt is 1,2-benzisothiazol-3(2H)-one or a derivative salt of 1,2-benzisothiazol-3(2H)-one.

17. The antimicrobial mix of claim 15, wherein the second biocide comprises 8-hydroxyquinoline, a derivative thereof, or combinations thereof

18. A method of preparing an antimicrobial solution, the method comprising:
mixing the elements of the antimicrobial mix of claim 15;
adding water of the mixed elements; and
shear mixing or vortexing the water with the mixed elements.

19. An antimicrobial substrate comprising:
a surface;
a first biocide comprising a compound having at least one Schiff base;
a second biocide; and
a cross-linking agent configured to chemically bind the first and second biocides to the surface of the substrate.

20. The antimicrobial substrate of claim 19, wherein first biocide comprises 1,2-benzisothiazolin-3-one, a derivative thereof, or combinations thereof, the second biocide comprises 8-hydroxyquinoline, a derivative thereof, or combinations thereof or pyridine, a derivative thereof, a co-polymer thereof, a homo-polymer thereof, or combinations thereof, and the cross-linking agent is a siloxane, an acrylate, an epoxide, or combinations thereof.
